(19) United States
(12) Patent Application Publication
(10) Pub. No.: US 2016/0019217 A1
(43) Pub. Date: Jan. 21, 2016

(54) SYSTEMS AND METHODS FOR RECOMMENDING MEDIA ITEMS

(71) Applicant: MediaGraph, LLC, Berkeley, CA (US)

(72) Inventors: Orion Reblitz-Richardson, Berkeley, CA (US); Alex Lee Kerfoot, Oakland, CA (US); Randall Breen, San Rafael, CA (US); Sina Jafarzadeh, San Francisco, CA (US); A. Peter Swearengen, San Francisco, CA (US); William Ralph Wright, Oakland, CA (US)

(21) Appl. No.: 14/716,061

(22) Filed: May 19, 2015

Related U.S. Application Data
(63) Continuation of application No. 14/714,705, filed on May 18, 2015.
Application No. 14/714,705 is a continuation of application No. 14/336,997, filed on Jul. 21, 2014.

(51) Int. Cl. G06F 17/30

(52) U.S. Cl. CPC G06F 17/3053; G06F 17/30029; G06F 17/30061

(57) ABSTRACT

Large media libraries containing songs, movies, or images, can be organized as a graphical media map. Depending on the contents of a particular large media library, the media map can have empty cells that do not correspond to a media item in the media library. To fill these cells with meaningful recommendations based on media items that are already in the library, a recommendation system provides a recommendation of a media item for a particular cell based on the media items corresponding to cells proximate to the cell. The recommendation is generated using metadata tags describing the nearby media items and media items that are not currently part of the media library. The recommendations can be updated based on changes made to the media map.

### PRIORITY CLAIM

This non-provisional U.S. patent application is a continuation of U.S. patent application Ser. No. 14/714,705 filed May 18, 2015, which is a continuation of U.S. patent application Ser. No. 14/336,997 filed Jul. 21, 2014, which is a continuation of U.S. patent application Ser. No. 14/214,372 filed Mar. 14, 2014, which claims priority to, and the benefit of, U.S. Provisional Patent Application No. 61/800,577 filed Mar. 15, 2013 and U.S. Provisional Patent Application No. 61/928,626 filed Jan. 17, 2014, the entirety of each of which is hereby incorporated by reference herein.

### BACKGROUND

1. Field

This patent application is directed generally to managing libraries of content, and, more specifically, to providing recommendations of media items to add to the libraries of content.

2. Description of Related Art

With the rise of digital media, personal libraries of media items (e.g., music, movies, and images) have grown dramatically. These large libraries can be difficult to organize in a meaningful way to allow a user to locate items of interest and identify relationships between items. As the size of media libraries continues to increase, the need for efficient and accurate curation of such media libraries becomes ever more urgent.

Further, once a media library is generated, the user may realize that his collection is incomplete but may not have the motivation or requisite knowledge to fill any gaps. While other recommendation systems exist, especially those used in online marketplaces, these recommendations are made using a limited amount of contextual data. For example, Amazon provides recommendations based on the product being viewed by the user (e.g., people that looked at this item also looked at these items) or single category page in the context of a search result. In Pandora, recommendations are given sequentially as the next song within a continuous linear playlist based on similarity to a single song or artist or a select combination of songs or artists. To make meaningful recommendations, additional context is needed in environments that capture many degrees of nuanced similarity.

### SUMMARY

According to some embodiments, a method comprises: obtaining, by a computing system, a stored media map, the media map comprising media map cells corresponding to media items and at least one filler cell, the media map including a plurality of regions, each region comprising a portion of the media map cells; identifying, by the computing system, a filler cell in a region of the plurality of regions; generating, by the computing system, a recommendation of a media item for placement in the filler cell by: deriving a restriction and a recommendation archetype for the filler cell from metadata tags describing the media items corresponding to the portion of the media map cells of the region comprising the filler cell, accessing metadata tags describing media items that do not correspond to any of the media map cells, filtering a set of recommendations of media items based on the accessed metadata tags and the restriction, and selecting one of the filtered set of recommendations based on similarity scores indicating a relative similarity of the recommendation archetype and each of the media items in the filtered set of recommendations; and presenting the selected recommendation in the filler cell of the media map to a user via a user display device.

According to some embodiments, a system comprises: a communication module configured to obtain, by a computing system, a stored media map, the media map comprising media map cells corresponding to media items and at least one filler cell, the media map including a plurality of regions, each region comprising a portion of the media map cells; and a recommendation module configured to: identify, by the computing system, a filler cell in a region of the plurality of regions, generate, by the computing system, a recommendation of a media item for placement in the filler cell by: deriving a restriction and a recommendation archetype for the filler cell from metadata tags describing the media items corresponding to the portion of the media map cells of the region comprising the filler cell, accessing metadata tags describing media items that do not correspond to any of the media map cells, filtering a set of recommendations of media items based on the accessed metadata tags and the restriction, and selecting one of the filtered set of recommendations based on similarity scores indicating a relative similarity of the recommendation archetype and each of the media items in the filtered set of recommendations, and wherein the communication module is further configured to present the selected recommendation in the filler cell of the media map to a user via a user display device.

According to some embodiments, a non-transitory computer-readable media has instructions embodied thereon, the instructions executable by one or more processors to perform operations comprising: obtaining a stored media map, the media map comprising media map cells corresponding to media items and at least one filler cell, the media map including a plurality of regions, each region comprising a portion of the media map cells; identifying a filler cell in a region of the plurality of regions; generating a recommendation of a media item for placement in the filler cell by: deriving a restriction and a recommendation archetype for the filler cell from metadata tags describing the media items corresponding to the portion of the media map cells of the region comprising the filler cell, accessing metadata tags describing media items that do not correspond to any of the media map cells, filtering a set of recommendations of media items based on the accessed metadata tags and the restriction, and selecting one of the filtered set of recommendations based on similarity scores indicating a relative similarity of the recommendation archetype and each of the media items in the filtered set of recommendations; and presenting the selected recommendation in the filler cell of the media map to a user via a user display device.

### BRIEF DESCRIPTION OF THE DRAWINGS

FIG. 1 is an example of a media map, according to some embodiments.

FIG. 2 is an example of a hierarchical tree, according to some embodiments.

FIG. 3 is an example environment is which various embodiments can be implemented, according to some embodiments.

FIG. 4 is a flowchart of an example method for generating recommendations of media items for inclusion in the media map.

FIG. 5 is an example of labels assigned to nodes of a hierarchical tree, according to some embodiments.

FIG. 6 is an example table of metadata tags associated with media items, according to some embodiments.

FIG. 7 is an example portion of a media map having region labels.

FIG. 8 is an example portion of the media map highlighting filler cells where a recommendation can be made.

FIG. 9 is an example portion of a hierarchical tree having labels assigned to nodes thereof and showing where the recommendation can be made.

FIG. 10 is an example table containing restriction and recommendation archetypes, according to some embodiments.

FIG. 11 is an example portion of the media map including an accepted recommendation.

FIG. 12 is an example portion of a hierarchical tree having labels assigned to nodes thereof and showing the accepted recommendation.

FIG. 13 is an example portion of the media map highlighting filler cells in which further recommendations can be added.

FIG. 14 is an example portion of a hierarchical tree having labels assigned to nodes thereof and showing nodes where the further recommendations can be made.

FIG. 15 is an example portion of a media map.

FIG. 16 is an example portion of a hierarchical tree having labels assigned to nodes thereof.

FIG. 17 is an example portion of the media map containing a moved cell.

FIG. 18 is an example portion of the hierarchical tree having labels assigned to nodes thereof and showing the effect of moved cell on the hierarchical tree.

FIG. 19 is an example portion of the media map updated based on the movement.

FIG. 20 is an example portion of the updated hierarchical tree having labels assigned to nodes thereof based on the movement.

### DETAILED DESCRIPTION

With the advent of large collections of digital content, various systems and methods can be used to organize the content so as to reflect relationships between the media items. When these relationships are exposed in a graphical presentation or arrangement of the media items, holes or gaps in the collection can be made apparent to the user. To fill the holes or gaps, a system and a method as described herein provide recommendations of media items.

The provided recommendations are similar to the media items positioned near the area where the recommendation is made in the media map. To make the recommendations, the system and the method use labels corresponding to regions in the media map and metadata tags associated with neighboring media items to derive a restriction and a recommendation archetype. Using the restriction, a set of recommendations is determined. Using the recommendation archetype, the set is refined until a media item is selected to be recommended to the user of the media map.

Each recommendation can be accepted or rejected by the user, at which point new recommendations are made. If the user accepts the recommendation, the recommended media item is added to the media map. Another recommendation can be generated in case the user rejects a presented recommendation or the user moves or rearranges other media items within the media map. The recommendations can be made or presented one-by-one or simultaneously at different locations within the media map. The recommendations allow the user to further expand the content library in a cohesive and comprehensive manner.

More specifically, the system and the method for recommendation leverage the relationships between content (such as digital media in the form of songs or video files). Information about these files (metadata) is accessed from content creators (musicians, filmmakers, writers), publishers (Sony, Warner Brothers), distribution services (Amazon, Apple), data services (Gracenote, Rovi) and user generated content (UGC) and is combined to determine the distribution of the media items in the graphical presentation.

Using the media map, and as described in the U.S. patent applications of which this U.S. patent application is a continuation, relationships between content can be limited, filtered, or enhanced to isolate specific types of relationships such as sorting by year or a combination of factors such as sorting by year and genre. Regions in the map can be represented by the names of representative media items or by labels describing attributes of the media item(s), such as year, genre, or mood. Maps can be persistent such as by category and subcategory in a predetermined order (genre and subgenre) or as semi-persistent, editable representations of libraries that change over time. The media maps can be personally organized with curated material representing the individual's taste and preference for association. These maps provide context to the generated recommendations because the recommendations are positioned relative to the media items included in the media map.

In one example embodiment, the media items are arranged in a hierarchy and each media item is associated with one or more metadata tags from which its similarity to other media items can be calculated. In embodiments that use a media map, recommendations are placed in subdivisions, referred to as “filler cells”, of existing cells that, in turn, correspond to a media item. The recommendations can be limited on a per region basis.

In another example embodiment, the media items are organized into a tree hierarchy and recommendations are made in empty nodes. These empty nodes can correspond to the filler cells of the above embodiment.

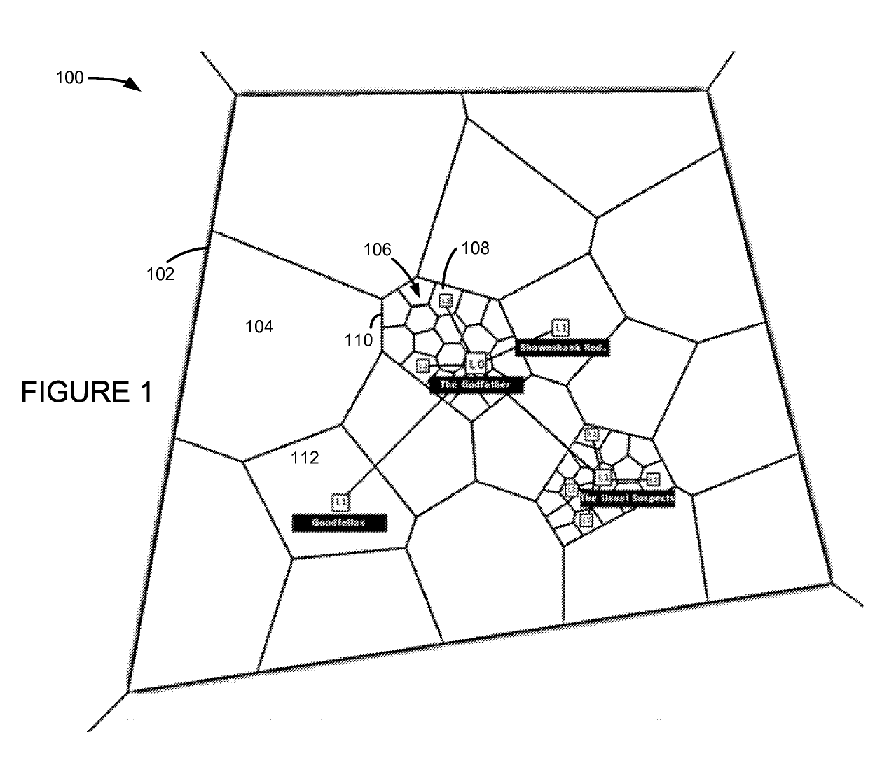

FIG. 1 is an example of a media map 100, according to one embodiment. The media map 100 is generated as a Voronoi diagram. Voronoi diagrams are used by mathematicians to divide a two-dimensional region into a number of cells, where each cell identifies a region about a point. Given a set of points distributed in space, Voronoi diagrams can be quickly generated and/or re-generated by computers. By manipulating the positions of the set of points, the Voronoi diagram can be changed. Further, mathematical techniques, such as Lloyd's relaxation, can be used to refine Voronoi diagrams.

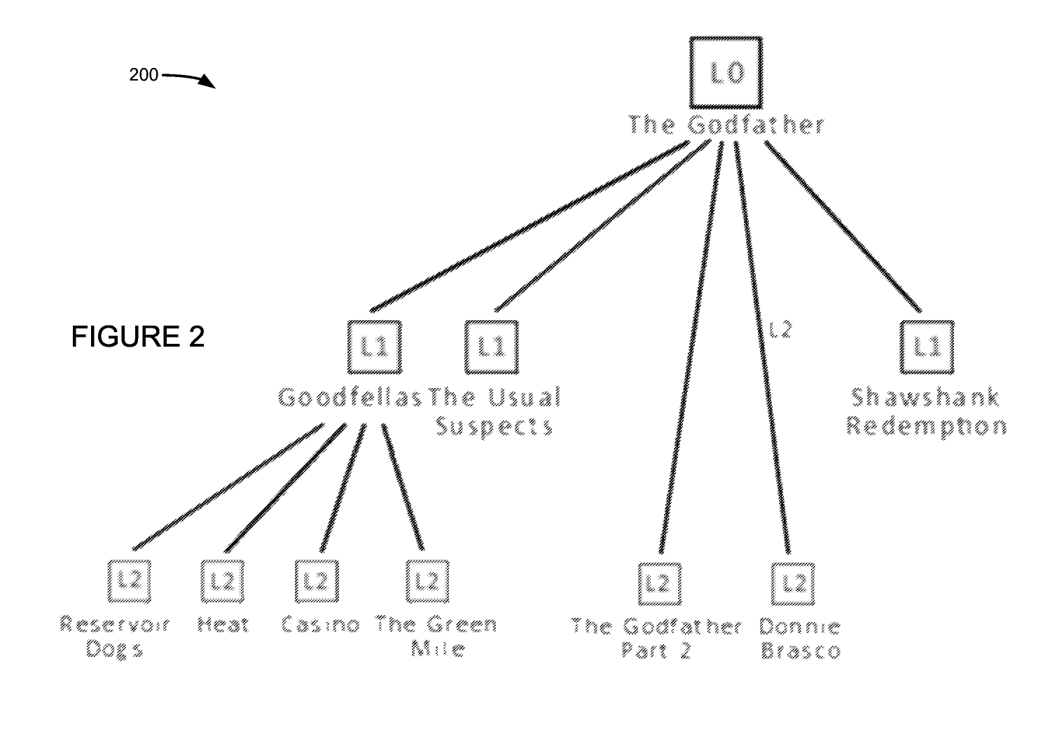

The media map 100 includes a number of Voronoi cells that each are assigned to, and represent, a corresponding media item, a pseudo node, or a filler node in a hierarchical tree (as described in greater detail in connection with FIG. 2). The media map 100 has similar media items placed in proximity to other similar media items and according to a hierarchy where a media item can be the parent or the child of another media item. Child media items are positioned within a subdivision of the Voronoi cell that represents the parent media item.

The size of the cell depends on a prominence level of the media item, the pseudo node, or the filler node. The prominence level of a media item is a quantitative indication of its popularity relative to other, similar media items. Media items having a higher prominence level are assigned to larger Voronoi cells than media items having a lower prominence level.

In the media map 100, the prominence levels of the media items, and by association, the Voronoi cells representing the media item, are indicated within a square having the identifiers: “L0”, “L1”, and “L2”. In the embodiment shown, the prominence level “L0” is associated with the media item having the highest prominence level, the prominence level “L1” is associated with the media items having the next lower prominence level, and the prominence level “L2” is associated with the media items having a further lower prominence level. Similarly, the Voronoi cells within the media map 100 are of a size corresponding to the prominence level of the media item. For example, the movie “The Godfather” has a prominence level L0 and is assigned to a Voronoi cell 102. Subdivided cells can each respectively represent a child media item of the L0 media item in the hierarchical tree having a prominence level of L1. As such, media items that are siblings in the hierarchical tree are positioned in proximity to one another in the media map 100. The Voronoi cell 102 is subdivided into Voronoi cells such as Voronoi cell 104 being a filler cell, Voronoi cell 110 assigned to a level L1 pseudo node, and Voronoi cell 112 assigned to an L1 child of “The Godfather”. For example, and as depicted in FIG. 1, the Voronoi cells 110 and 112 can be subdivided further into Voronoi cells such as Voronoi cell 106 if the assigned media item has at least one child media item. The further subdivided cells 106 in the Voronoi cell 110 can each, like Voronoi cell 108, respectively represent a child media item of a media item that has an L2 prominence level in the hierarchical tree. In this example, the Voronoi cell 106 is a filler cell.

The media map 100 can be displayed, navigated and edited via one or more user interactions with a user interface, as described in U.S. patent application Ser. No. 14/714,705, of which this application is a continuation application.

Referring now to FIG. 2, an example hierarchical tree 200 is depicted. In some instances, the media map 100 is generated from the hierarchical tree 200. Any changes made to the arrangement of the media items in the media map 100 can affect the arrangement of the media items in the hierarchical tree 200, and vice-versa. The hierarchical tree 200 is an organization of media items into a structure that reflects similarity and relative prominence between the media items. Systems and methods for generating the hierarchical tree and prominence levels are described in U.S. patent application Ser. No. 14/214,372, of which this application is a continuation application.

The hierarchical tree 200 has leaf and non-leaf nodes that are media items. Assigning media items as non-leaf nodes and, therefore, representatives for a tree or a sub-tree means the media item (for example, “The Godfather”) stands for and represents an entire tree or sub-tree. A media library (e.g., media library 306, discussed below) typically includes multiple hierarchical trees, with each hierarchical tree having a root node or representative (the media item in the hierarchical tree having the highest prominence level) and each sub-tree having its own representative. The root media item can have children of different prominence levels. The trees can be laid out such that each tree is radial around the root node, creating clusters and sub-clusters of representative content.

In the hierarchical trees, every node has a distinct prominence level. The prominence levels start at the most prominent (and, in an embodiment, largest when displayed on the screen) labelled “L0,” and progress to lower levels of prominence such as L1, L2, L3, L4, L5, etc. (it is to be noted that, as is thus clear, a lower prominence number represents a higher prominence level). The prominence level of a given media item can be represented in the form PROM_LEVEL (media), which outputs an Lx value. The prominence level of the media item is not directly linked to its position within the hierarchical tree structure, but is initially a calculated prominence value indicating the relative popularity of the media item and can be adjusted by the user. The prominence level can be used to determine how the media item is depicted within a user interface (e.g., media items having a higher prominence level can be depicted by icons that are larger than icons that represent media items having a lower prominence level). When the hierarchical trees are obtained, the child nodes within the hierarchical tree are invariably at a prominence level that is lower than the prominence level of its parent.

Referring again to FIG. 2, hierarchical tree 200 is shown having media items (in this example, movies) with prominence levels. Each media item that is a node in the hierarchical tree has a prominence level shown internal to the square adjacent to the label identifying the media item. In FIG. 2, “The Godfather” is the L0 root node of a hierarchical tree that has “Goodfellas” as an L1 representative node for the children: “Reservoir Dogs”, “Heat”, “Casino”, and “The Green Mile”. “The Usual Suspects” and “Shawshank Redemption” have no children (and only represent themselves because they have no children) and are denoted as L1, which means they are at the same prominence level as “Goodfellas”. “The Godfather Part 2” and “Donnie Brasco” are denoted as L2, but are parented to (and are thus represented by) only “The Godfather”. This means that “The Godfather” is both their L0 and L1 representative. “The Godfather Part 2” and “Donnie Brasco” (both denoted as L2) have the same prominence level as “Reservoir Dogs”, “Heat”, etc. (other L2 items) but they are positioned below or around “The Godfather” when the hierarchical tree is displayed.

From the media map 100 or the hierarchical tree 200, the user can identify relationships and similarities between media items. Further, by arranging the media items, gaps or holes in the user's collection can be identified. The gaps or holes in the collection can be explicitly included in the media map 100 as empty filler cells among the subdivisions in the media map 100 or in the hierarchical tree 200 as empty leaf nodes. Recommendations for adding media items to the user's collection at the empty filler cells or the empty leaf nodes can be made using metadata associated with the neighboring media items.

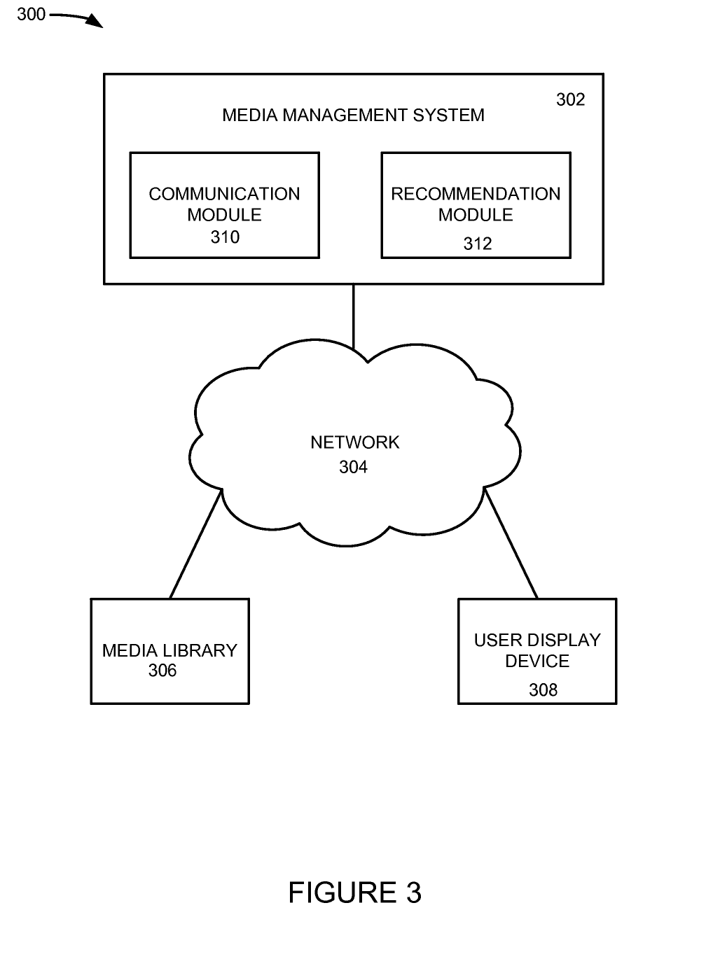

Referring now to FIG. 3, an example environment 300 in which various embodiments can be practiced is shown. In the example environment 300, a media management system 302 is configured to obtain a hierarchical tree (e.g., hierarchical tree 200) or a media map (e.g., media map 100) via a network 304 (e.g., the Internet). The media management system 302, upon obtaining the media items (or identifiers thereof), the hierarchical tree, and/or the media map from a media library 306, can generate a recommendation within the media map or the hierarchical tree (e.g., media map 100 or hierarchical tree 200, respectively). The media management system 302 can transmit the generated recommendation across the network 304 to one or more user display devices 308 for display and to receive user input about the recommendations. The user display device 308 can receive an instruction from the user to accept or reject the recommendation and transmit the instruction over the network 304 to the media management system 302. The media management system 302 can interpret the received instruction, and modify the media map, the hierarchical tree, and one or more recommendations accordingly.

The media management system 302 comprises a communication module 310 and a recommendation module 312. The media management system 302 can be implemented in a variety of ways known to those skilled in the art including, but not limited to, as a computing device having a processor with access to a memory capable of storing executable instructions for performing the functions of the described modules. The computing device can include one or more input and output components, including components for communicating with other computing devices via a network (e.g., the network 304) or other form of communication. The media management system 302 comprises one or more modules embodied in computing logic or executable code such as software.

In some embodiments, the communication module 310 obtains a media map from the media library 306 or from a media map system (e.g., the media map system described in U.S. patent application Ser. No. 14/336,997 filed Jul. 21, 2014, of which this patent application is a continuation) via the network 304. In some instances, the media map system, the client display device 308, and/or the media library 306 can be co-located with the media management system 302. The media management system 302 is configured to receive instructions from a user using the user display device 308 (e.g., via the network 304) to display the media map including one or more recommendations and to accept or reject those recommendations. The media management system 302 then executes the instruction and makes changes to the media map as necessitated by the instruction and as described herein. After the media map is modified, the communication module 310 can provide a display of the modified media map to the user display device 308.

The recommendation module 312 is configured to generate a recommendation based on the obtained media map for an identified filler cell. The recommendation module 312 is configured to derive a restriction and a recommendation archetype for the identified filler cell from the labels within the region in which the filler cell is located. The recommendation module 312 then filters possible recommendations using the restriction and selects a media item from the filtered possible recommendations to recommend to the user using the recommendation archetype. The recommendation module 312 provides the recommendation to the communication module 310 which can then present the recommendation to the user via the user display device 308.

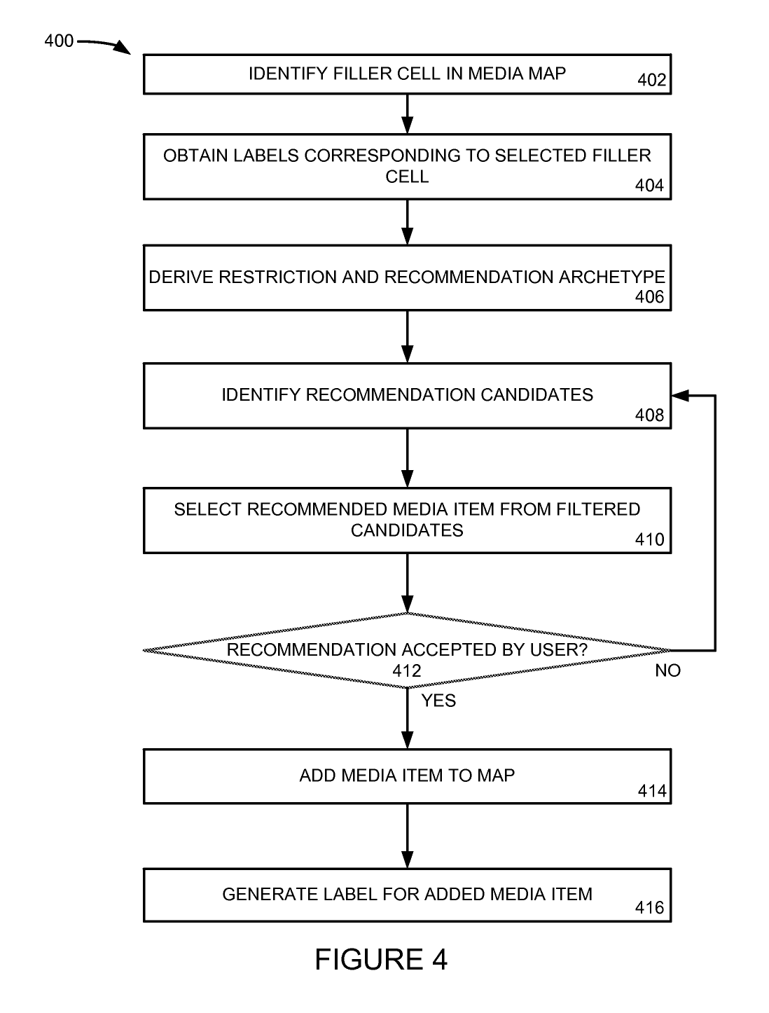

Referring now to FIG. 4, a flowchart of an example method for generating recommendations for inclusion in the media map and the hierarchical tree is depicted. The method 400 can be performed by, for example, the media management system 302.

In an operation 402, an empty filler cell in the media map is identified. The filler cell can be identified at random or based on one or more factors such as, but not limited to, proximity to cells that correspond to media items, relative density of cells in a region that correspond to a media item, or the presence of cells corresponding to media items in adjacent regions of the media map.

In an operation 404, the labels that correspond to the identified filler cell are obtained. As described in U.S. patent application Ser. No. 14/714,705, of which this application is a continuation, the cells within the obtained media map can be assigned to labels. The labels corresponding to the parent and neighbor cells of the identified filler cell can be used to collectively describe a media item that can be an appropriate recommendation for the identified filler cell.

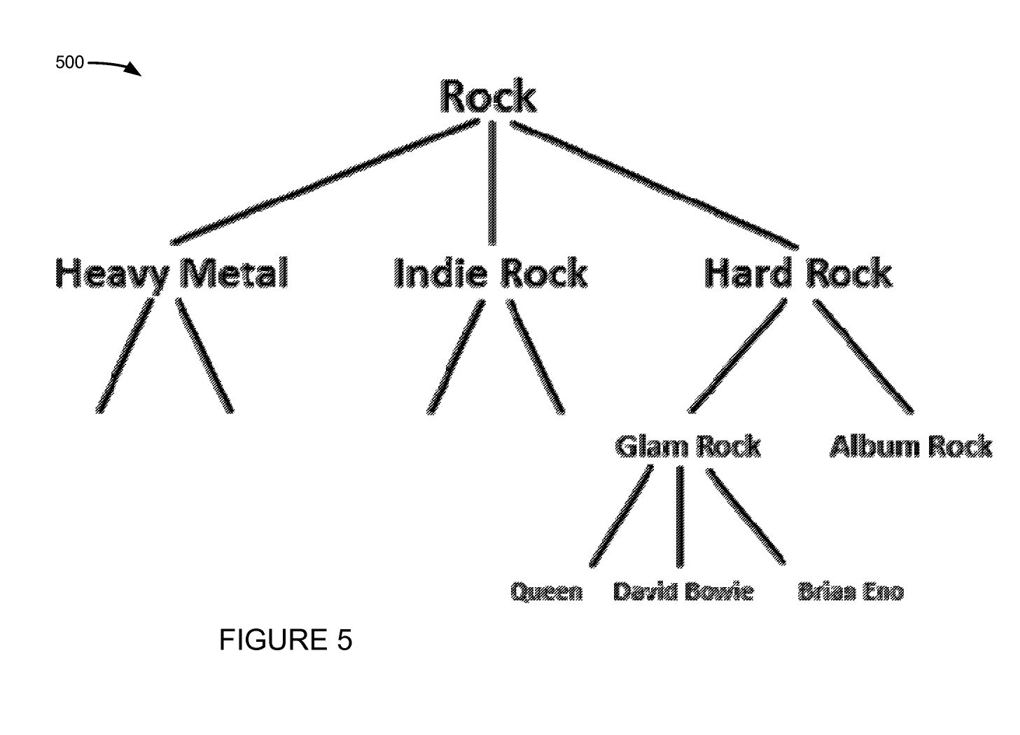

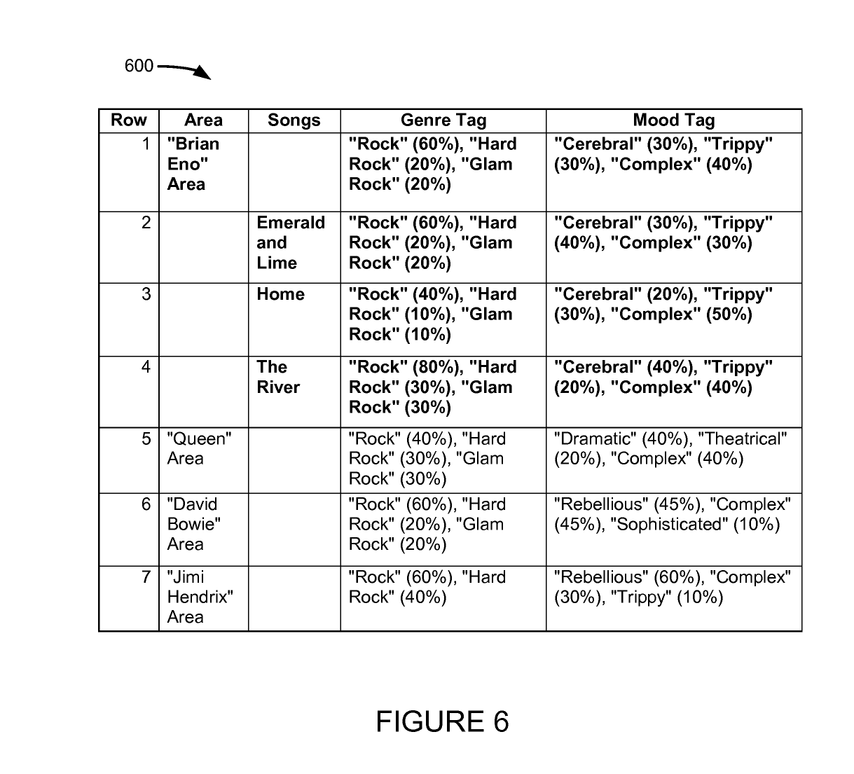

To illustrate, FIG. 5 depicts the labels corresponding to a selected portion of a media map as a tree 500, according to some embodiments. As depicted in FIG. 5, the L0 prominence level of the tree 500 is labelled “Rock” and the L1 prominence level of the tree 500 is separated into subtrees “Heavy Metal”, “Indie Rock”, and “Hard Rock”. As depicted, the “Hard Rock” subtree includes two child nodes at level L2, “Glam Rock” and “Album Rock”. The L3 level beneath “Glam Rock” has three nodes, labelled “Queen”, “David Bowie”, and “Brian Eno.” These labels were derived from tags associated with the media item assigned to the node (as described in U.S. patent application Ser. No. 14/714,705, of which this application is a continuation), some of which are shown in FIG. 6. FIG. 6 is an example table 600 of metadata tags associated with media items, according to some embodiments, and includes tags that describe the genre and mood of the media items assigned the labels of FIG. 5. Table 600 contains the values and weights of labels for the categories “Genre” and “Mood” provided by third party vendors and user tagging for the songs “Emerald and Lime”, “Home”, and “River” all by Brian Eno. The complete set of collected and averaged labels for the media items corresponding to the cells and assigned to subdivisions within the cells are labelled “Brian Eno Area”, “Queen Area”, and “David Bowie Area,” respectively. The row labelled “‘Jimi Hendrix’ area” is used as part of an example discussed below.

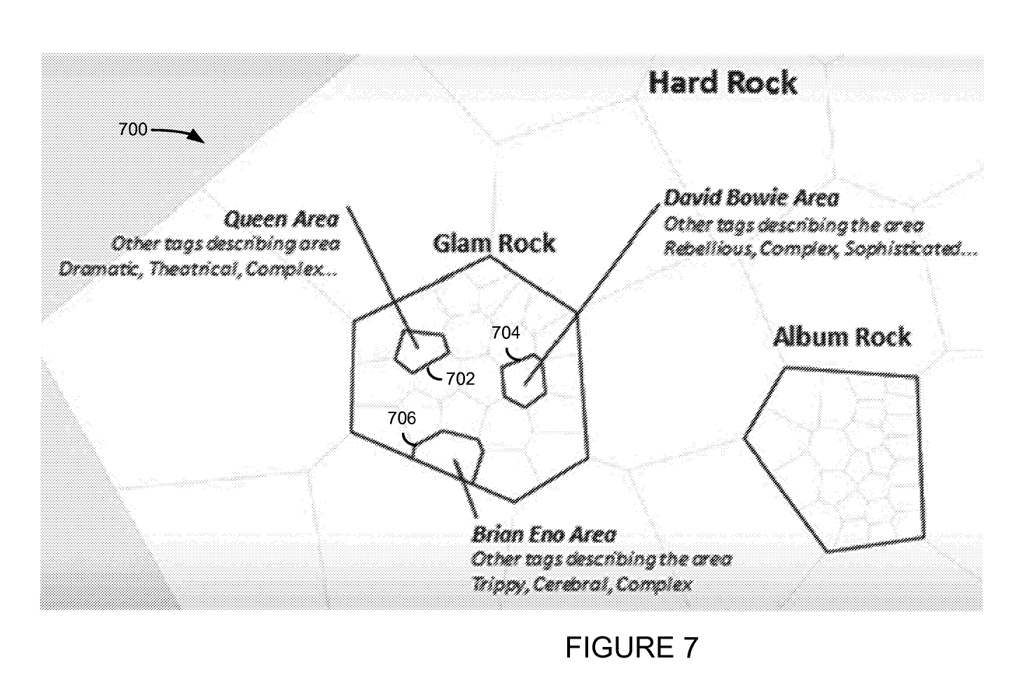

Referring again to FIG. 4, in operation 404, the method 400 obtains visible tags (e.g., labels) as well as non-visible tags accumulated from all media items corresponding to the parent cells of the media map containing the filler cell identified in the operation 402 to derive the restriction and the recommendation archetype in an operation 406. FIG. 7 is an example region of a media map 700 having region labels for the region labelled “Hard Rock” that includes the subdivisions listed in FIG. 6, Table 600 and in the hierarchical tree 500 of FIG. 5. In the media map 700, there is an area 702 mostly containing media items by Queen, an area 704 mostly containing media items by David Bowie and an area 706 mostly containing media items by Brian Eno. These areas have their primary genre conveyed as labels (“Rock”, “Hard Rock” and “Glam Rock”), but also a number of other common tags. In the example, the Queen area 702 (see FIG. 6, Table 600, Row 5) also has the tags “Dramatic”, “Theatrical” and “Complex” describing its characteristics.

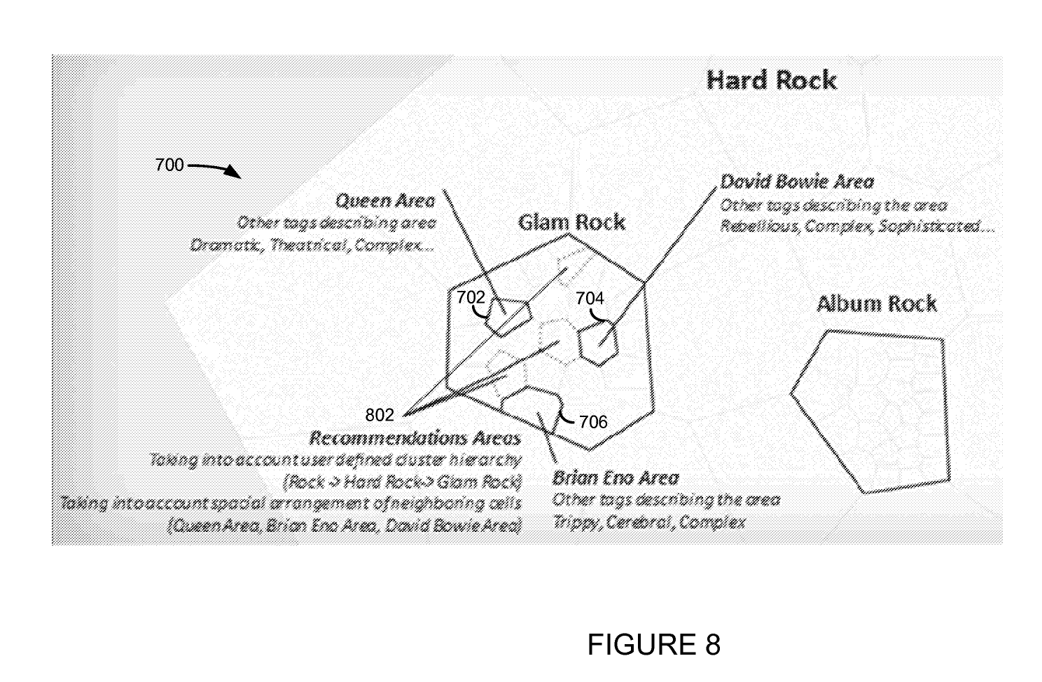

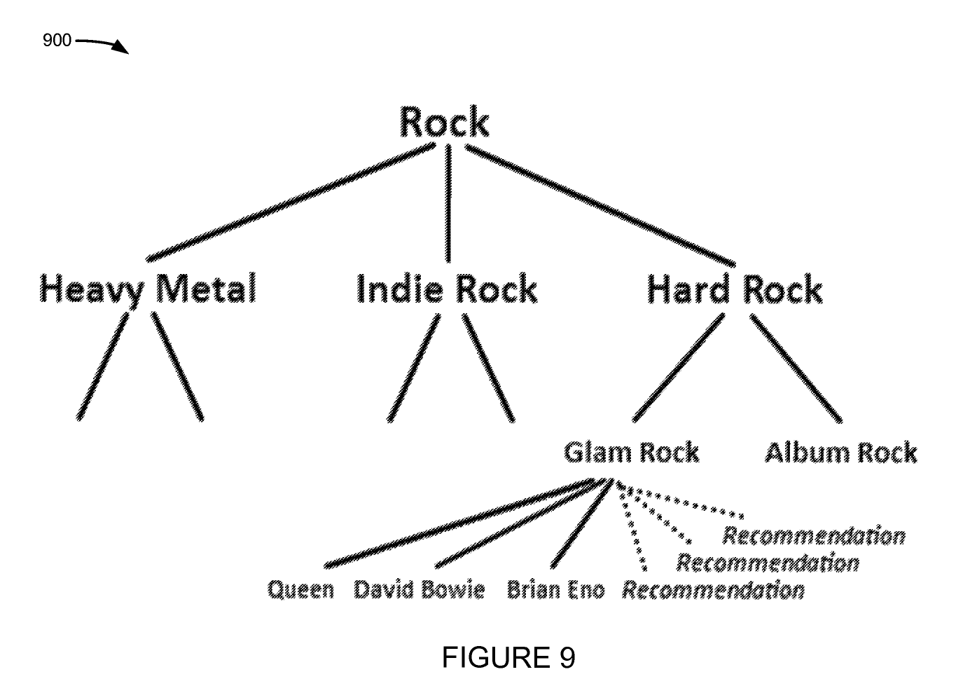

FIG. 8 is an example portion of the media map 700 highlighting filler cells 802 identified in the operation 402 where a recommendation can be made. The highlighted filler cells 802 can each be adjacent to another cell to which a label and media item is assigned. In some instances, a filler cell adjacent to a boundary between higher-level cells can be identified. FIG. 9 is an example portion 900 of a tree showing the labels corresponding to the media map 700 shown in FIG. 8 into which the recommendation can be made. The portion 900 of the tree includes three empty L3 leaf nodes labelled “Recommendation” that are not assigned to a media item and that correspond to the identified filler cells 802.

Returning to FIG. 4, in an operation 406, a restriction and a recommendation archetype are derived from the labels describing the identified filler cell (e.g., the labels shown in tree 500) and mood tags of cells adjacent to the identified filler cell in the media map. After the restriction is used to identify a set of possible recommendations, the recommendation archetype provides a context used to select a recommended media item for the identified filler cell. The restriction and the recommendation archetype are characterized by a set of weighted tags collected from the hierarchical parentage and siblings.

The restriction is used to filter the possible recommendation from all the available media items in an operation 408, described below. To calculate the restriction, the weighted union of area labels is determined. These are collected from each of the hierarchical parent cells.

To calculate the recommendation archetype, a weighted union of area labels and cell neighbor tags is calculated. The area labels are collected from each of the hierarchical parent cells of the identified filler cell. The weighted tags are collected from neighboring media items located on adjacent subdivisions of the immediate parent cell. If the filler cell is on the border of its parent cell, weighted tags are collected from neighboring media items outside of the parent cell and adjacent to the parent cell. In an embodiment, area label weights (included as percentages in the lists of metadata tags of FIG. 6) are multiplied by a factor of 50% and cell neighbor tags are multiplied by a factor of 50%. These factors can be adjusted by a user and can range from 0% to 100%. These tags are then combined using a union operation and weights are accumulated for repeating tags. To illustrate, referring back to the examples of FIGS. 5-8, the restriction and recommendation archetype are calculated for the filler cell adjacent to the cell 706 labelled “Brian Eno.” The input into the operation 406 comprises the area labels and the cell neighbor tags from the media items corresponding to the Brian Eno cell 706.

To calculate the restriction in operation 406 that will be used to filter possible recommendation candidates, the weighted union of area labels is calculated. For the identified filler cell, this results in “Rock” (60% of Genre), “Hard Rock” (20% of Genre), “Glam Rock” (20% of Genre) (see FIG. 6, Table 600, Row 1).

To calculate the recommendation archetype in operation 406 for the same filler cell, the weighted union of area labels plus cell neighbor tags is determined. The influence from the parent area labels is “Rock” (60% of Genre), “Hard Rock” (20% of Genre), “Glam Rock” (20% of Genre) (see FIG. 6, Table 600, Rows 1-4). The influence from the neighboring Brian Eno cell 706 is “Rock” (60% of Genre), “Hard Rock” (20% of Genre), “Glam Rock” (20% of Genre), “Cerebral” (30% of Mood), “Trippy” (30% of Mood), “Complex” (40% of Mood) (see FIG. 6, Table 600, Row 1). Area labels are multiplied by a factor of 50% and neighbor tags are multiplied by a factor of 50%, so the combined tags, and resulting archetype, is “Rock” (60% of Genre), “Hard Rock” (20% of Genre), “Glam Rock” (20% of Genre), “Cerebral” (15% of Mood), “Trippy” (15% of Mood), “Complex” (20% of Mood) (see FIG. 6, Table 600, Row 1).

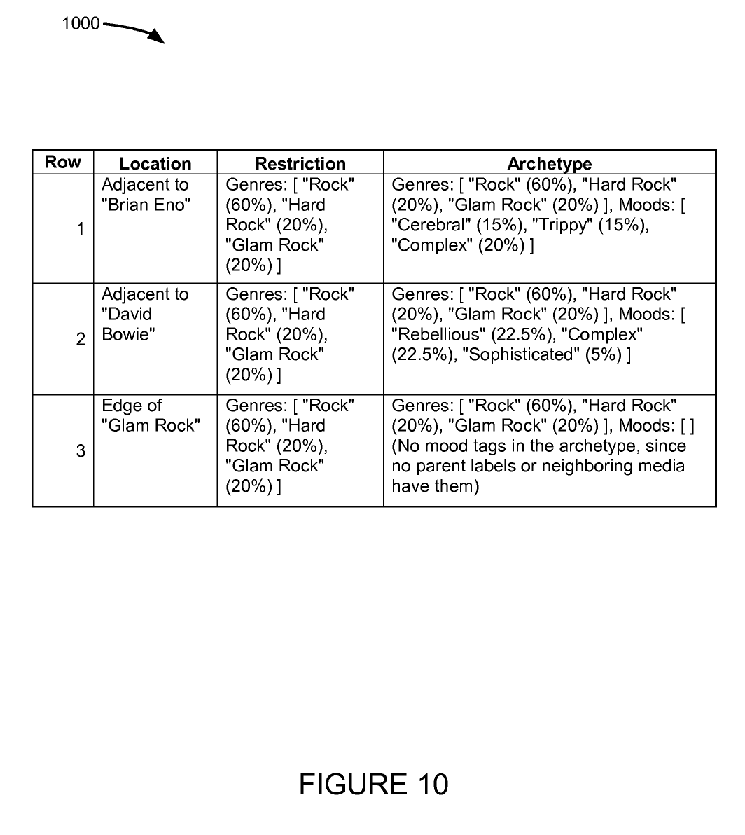

The calculated restriction and recommendation archetypes for the three filler cells 802 shown in FIG. 8, according to this example, are shown in FIG. 10. The restriction and recommendation archetypes are determined according to the same process used above to calculate the restriction and recommendation archetypes for the filler cell adjacent to the cell 706 labelled “Brian Eno”. The recommendation archetypes are then used to find the best match within the candidates for the identified filler cells.

Returning now to FIG. 4, in an operation 408, recommendation candidates are identified using the restriction. To provide interesting and accurate recommendations, the recommendation candidates are identified from a wide selection of media items. The media items and information about the media items can be aggregated from metadata providers such as Discogs, MusicBrainz, Rotten Tomatoes, and Wikipedia to populate a set of database tables containing the “pool” of recommendation candidates. Media items already existing on the media map are excluded. More specifically, the metadata tags within the restriction are matched to metadata tags associated with media items that are not included in the media library of the user (e.g., media library 306). As described below, recommendation candidates that were previously rejected by the user can also be excluded.

The recommendation candidates are filtered using the restriction generated as part of the operation 406. To constrain the set of recommendations, the recommendation candidates are filtered by the tags in the label hierarchy as expressed in the restriction. The results of the filtering include media items that can be positioned in the identified filler cell of the media map.

To illustrate, and based on the hierarchical tree 500 of FIG. 5, a pool of possible recommendations for the identified filler cells 802 within the “Glam Rock” region are filtered to only include those having the tags “Rock”, “Hard Rock” and “Glam Rock” (e.g., the direct parent labels of the filler cells in the cell labelled “Glam Rock” that also includes cells 702, 704, and 706 labelled “Brian Eno”, “Queen”, and “David Bowie”, respectively). Some categories of area labels, for example album names (because, e.g., the user might already have the whole album included in the media map), generic artists such as “Various Artists” and “Unknown Artist” can be disregarded. The results are ordered by prominence scores, as described in U.S. application Ser. No. 14/214,372 of which this application is a continuation, which are pre-determined scores collected from external providers like Rovi, Rotten Tomatoes, The Echo Nest, and users.

To illustrate, for the recommendation next to the Brian Eno cell 706 depicted as cell 802 in FIG. 8, the corresponding restriction is accessed. For this example, the restriction is: “Rock” (60% of Genre), “Hard Rock” (20% of Genre), “Glam Rock” (20% of Genre) (see FIG. 10, Table 1000, row 1). The tag weights are disregarded, yielding the tags: “Rock”, “Hard Rock”, “Glam Rock”. The media items that are recommendation candidates (from the operation 408) are filtered to include only those media items having metadata tags that match all of the labels included in the restriction (e.g., “Rock”, “Hard Rock”, and “Glam Rock”). In embodiments where the media items already included in the media map might be duplicated in the recommendation candidates, the recommendation candidates are further filtered to excluding all media items existing in user's collection (e.g., excluding “David Bowie”, “Brian Eno”, and “Queen” songs present in the media map or media library of the user). In instances where the user has previously rejected recommendations, the previously rejected recommended media items are excluded. In some instances, the remaining number of filtered recommendation candidates is limited to a predefined threshold, such as ten.

Returning to FIG. 4, in an operation 410, from the remaining recommendation candidates, the recommended media item is selected. To select the recommended media item, the best match from among the filtered set of recommendation candidates (from the operation 408) is determined by comparing the “recommendation archetype” generated in the operation 406 to all possible candidates. In some embodiments, this comparison is performed using the similarity system described in U.S. patent application Ser. No. 14/214,372 filed Mar. 14, 2014, of which this application is a continuation. The similarity system generates similarity scores between each the filtered recommendation candidates and the recommendation archetype as if it were an actual media item. The media item that is most similar (e.g., has a highest similarity score) to the recommendation archetype is selected.

In some embodiments, to improve the performance of the computing system, recommendation archetypes are generated for multiple filler cells on the media map. Recommended media items are filtered and selected as described in connection with the operations 408 and 410 for each of the identified filler cells. Because multiple recommendations are generated simultaneously, or substantially simultaneously, each recommended media item is only recommended once and is placed into a best possible location relative to the other media items and other recommendations in the media map.

To illustrate one instance of the operation 410, from the filtered set of the recommendation candidates resulting from the operation 408, a recommended media item is selected based on the spatial arrangement of the media items and the labels in the media map (e.g., as shown in FIG. 8, the cells 702, 704, and 706 labelled Queen, David Bowie, and Brian Eno, respectively) that each have their own characteristics, which are defined through the commonalties of their corresponding metadata tags. These recommendations are placed in the filler cells within the region of the media map for which they were selected. The positioning of each particular recommendation is determined based on the similarity of the media item to the other media items corresponding to the same region of the media map.

For the three recommendation locations highlighted in FIG. 8, the recommendation archetypes in table 1000 of FIG. 10 are used as inputs to the similarity algorithm, discussed in U.S. patent application Ser. No. 14/214,372 filed Mar. 14, 2014, of which this application is a continuation. For example, for the cell 802 next to the cell 706 labelled “Brian Eno”, the recommendation archetype is: “Rock” (60% of Genre), “Hard Rock” (20% of Genre), “Glam Rock” (20% of Genre), “Cerebral” (30% of Mood), “Trippy” (30% of Mood), “Complex” (40% of Mood) (see FIG. 10, Table 1000, Row 1). For the cell 802 next to the cell 704 labelled David Bowie, the recommendation archetype is: “Rock” (60% of Genre), “Hard Rock” (20% of Genre), “Glam Rock” (20% of Genre), “Rebellious” (45% of Mood), “Complex” (45% of Mood), “Sophisticated” (10% of Mood) (see FIG. 10, Table 1000, Row 2). For the cell at the edge of the region labelled “Glam Rock”, the recommendation archetype is: “Rock” (60% of Genre), “Hard Rock” (20% of Genre), “Glam Rock” (20% of Genre) (see FIG. 10, Table 1000, Row 3).

Another input into the similarity algorithm is the filtered list of a predefined number of recommendation candidates (e.g., generated in the operation 408) and their associated metadata tags. In some embodiments, the predefined number of recommendation candidates is based on the number of identified recommendation locations. In this example, there are three recommendation locations 802. Using a guideline of having ten recommendations per identified filler cell, the predefined number of recommendation candidates for the three recommendation locations 802 is thirty.

Returning to operation 410 of FIG. 4, a similarity matrix is computed using a similarity algorithm to compare the recommendation candidates and the recommendation archetypes. An example of the calculation of the similarity matrix is described in U.S. patent application Ser. No. 14/214,372 filed Mar. 14, 2014, of which this application is a continuation. The resulting similarity scores can be adjusted using category weights specified by the user. In this example, the media map is organized by the category “Genre”, so tags in the category “Genre” are weighted more heavily than tags in the category “Mood.” The weighting of categories is discussed in greater detail in U.S. patent application Ser. No. 14/214,372 filed Mar. 14, 2014, of which this application is a continuation. The resulting similarity matrix includes a similarity score between each of the recommendations and each of the recommendation archetypes. For example, the following songs by Brian Ferry have a calculated high level of similarity to the cell next to the Brian Eno cell 706: “Sign of the Times”, “This Is Tomorrow”, and “You Can Dance”. For each recommendation location and associated archetype, the recommendation with the highest similarity score is selected. A given recommended media item is only shown in one position on the map. So, if the media item is selected as a recommendation for one location, it is removed from consideration for other locations in the media map.

Once the selected recommendations are presented to the user via a user display device 308, the method 400 proceeds to an operation 412 in which a determination is made as to whether one or more of the recommendations have been accepted by the user.

In some embodiments, the user can accept and reject recommendations by clicking one of two buttons on a graphical user interface (GUI) where clicking on one of the buttons indicates acceptance at least one of the recommendations and the other button indicates rejection of at least one of the recommendations.

In an operation 414, the user accepting a recommendation adds the media item within the recommendation to the media library 306 and inserts the media item into the hierarchical tree and the media map at the location of the filler cell in which the recommendation was placed. In an operation 416, a label can be generated for the added media item using the process used to generate the other labels in the media map.

If the user instead rejects the recommended media item explicitly or by not accepting the recommendation in operation 412, the recommended media item is removed from the media map. In some embodiments, a record is generated that indicates that the media item has been rejected. The method 400 then returns to the operation 408 to select a new recommendation.

Whenever the user accepts a recommendation, different filler cells in the media map can be identified as locations for recommendations. New recommendation archetypes that account for the characteristics (e.g., media tags and generated region labels) from the accepted recommendations are calculated. The recommendation module 312 executes the same process when the user manipulates a media map by moving media items or by importing media items from an outside source. In each case, the restrictions and recommendation archetypes are recalculated as described above.

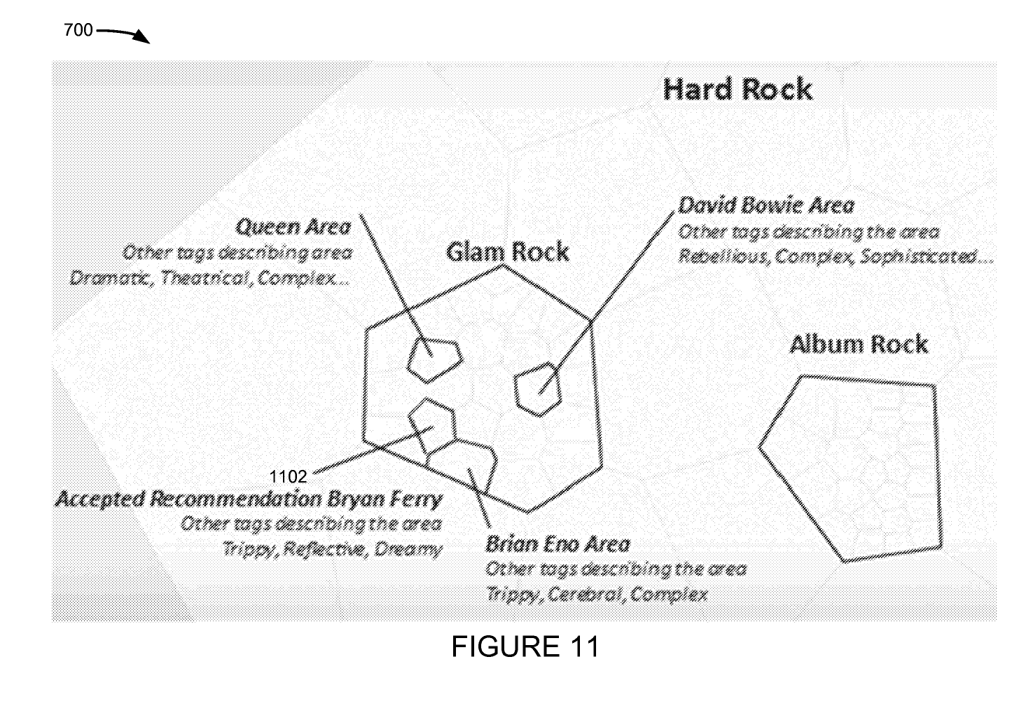

To illustrate, FIGS. 11-14 depict an example scenario where a user accepts a recommendation for a media item assigned the label “Brian Ferry” and positioned next to the cell labelled “Brian Eno”.

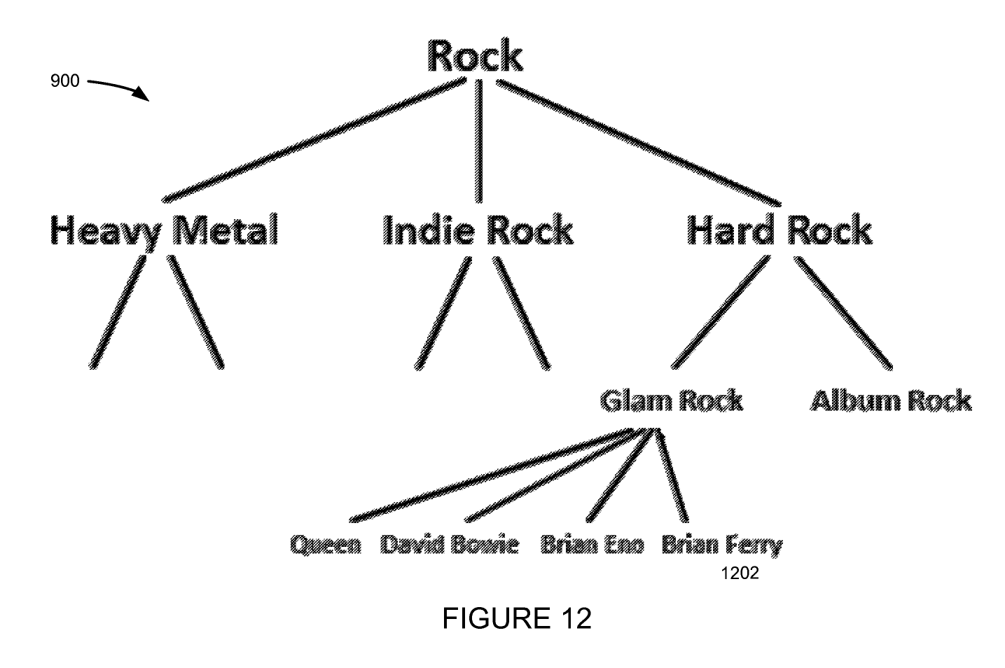

As depicted in an example portion of the media map 700 shown in FIG. 11, when the recommendation by “Bryan Ferry” is accepted by the user, the recommended media item is added to the map at the cell 1102, replacing the filler cell where it was recommended. The area labels (i.e., region labels) for the surrounding and nearby cells can also be updated to reflect the metadata tags of the added media item, but in this case there is no change except to add a label to the cell 1102, corresponding to accepted recommendation. The hierarchical tree corresponding to the region of the media map 700 is also updated to reflect the accepted recommendation. FIG. 12 is an example portion of a hierarchical tree 900 indicating the addition 1202 of “Brian Ferry”.

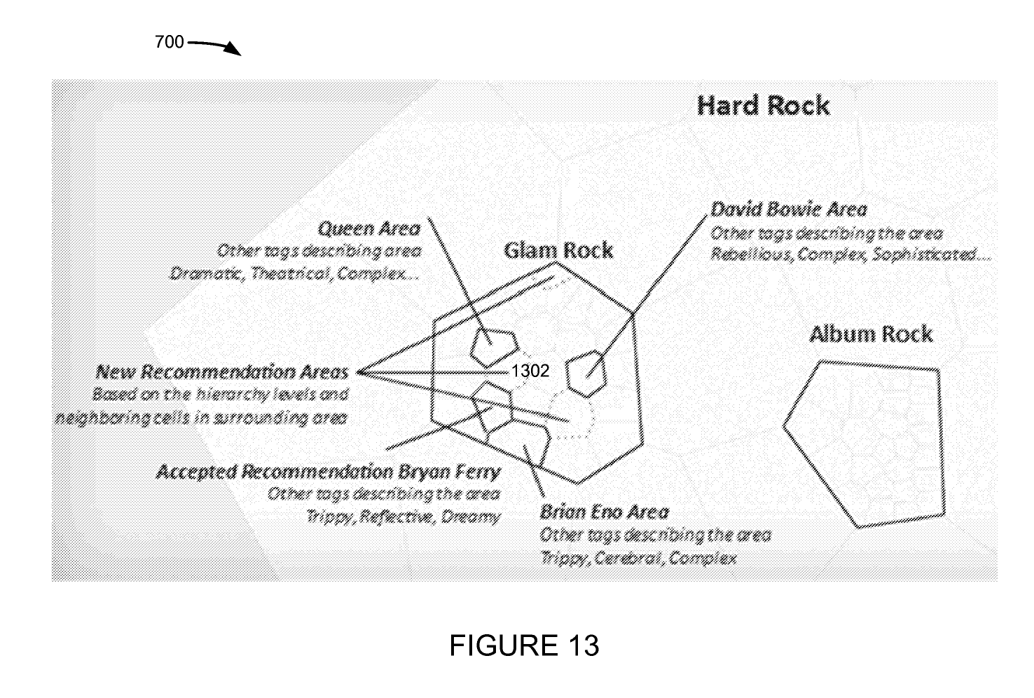

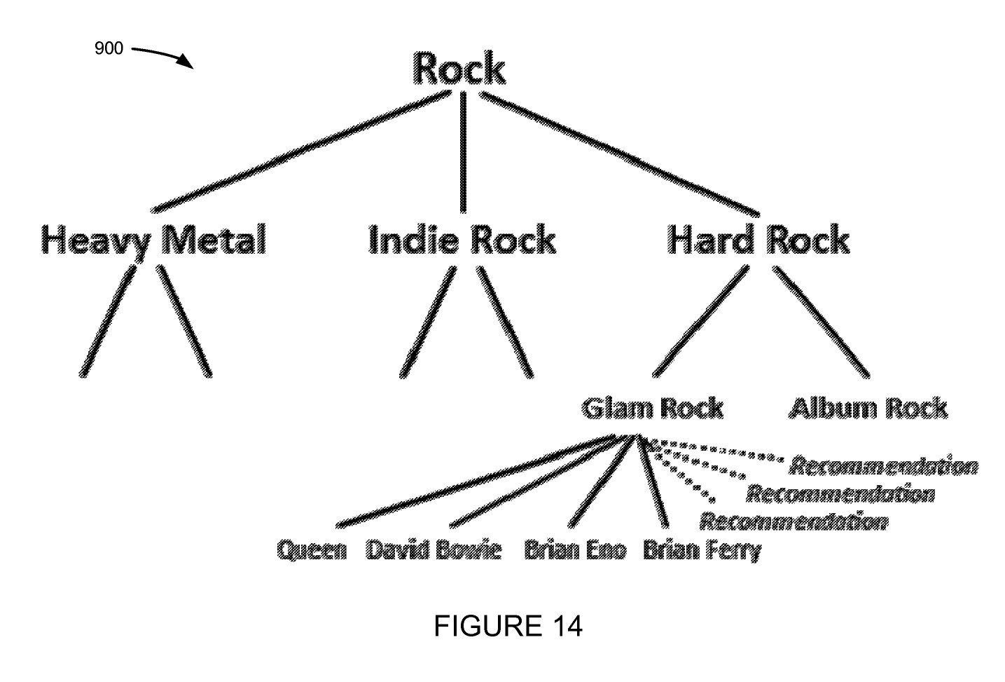

As shown in FIGS. 13 and 14, the method 400 can be repeated by identifying further filler cells in the media map 700 and hierarchical tree 900, respectively. According to the method 400, a new recommendation archetype (and restriction) is generated for the newly identified filler cells, taking into account the media item that has just been added to the media map 700. In this case, the newly identified filler cell 1302 for recommendation is between the cell 704 labelled “Queen” and addition 1202 labelled “Bryan Ferry”. In accordance with the method described above, the recommendation ultimately provided at the newly identified filler cell 1302 will be influenced by the mood tags associated with the media item(s) corresponding to the cell 704 labelled “Queen” and the addition 1202 labelled “Brian Ferry”.

When a user rejects a recommendation, a record of the rejection is generated and used to alter future recommendations. These rejected recommendations can either be excluded completely assuming that a rejected recommendation is of no interest to the user, or can be slowly re-introduced over time, assuming that the rejection is temporary. In some instances, when the user rejects a recommendation, after some time period, another recommendation candidate can be selected for the same location.

Whenever the user moves a media item in the media map 700, or moves a region of the media map 700, corresponding to more than one media item, from one position to another, the hierarchical tree and labels are also updated to reflect the change made by the user. The movement of a media item into and out of a region can result in a change of the most common tags within the region and within the corresponding sub-cluster of the hierarchy.

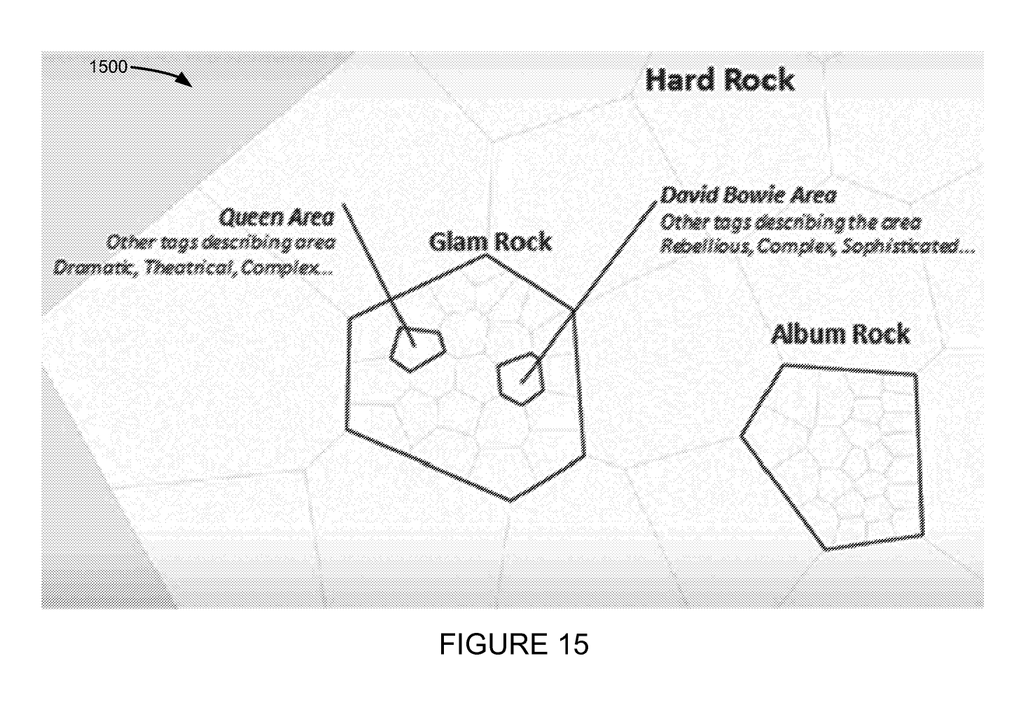

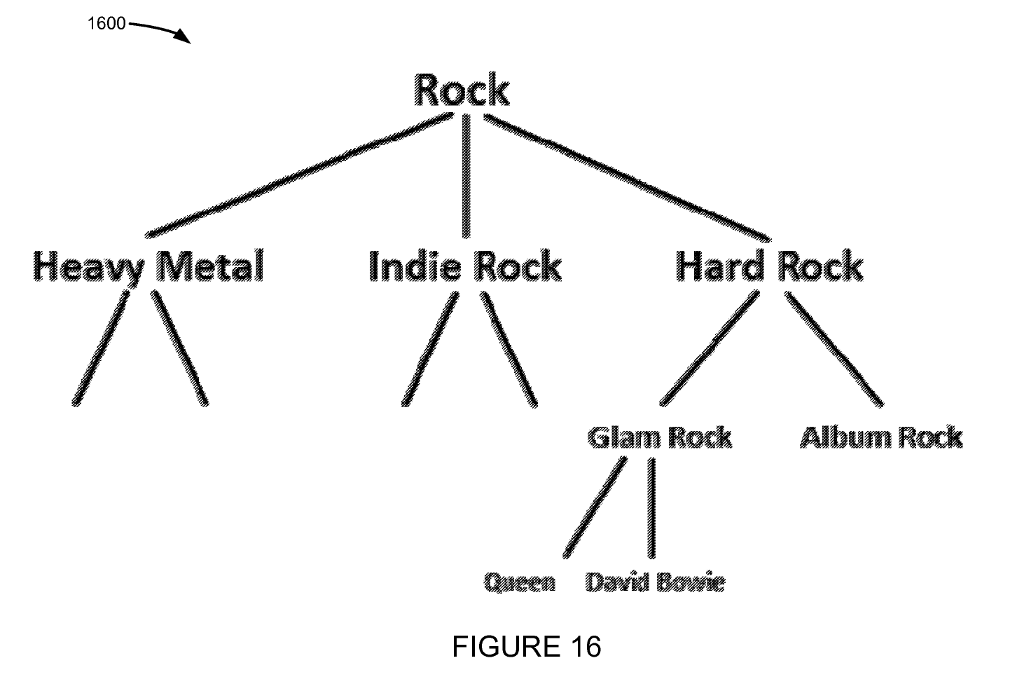

As depicted in an example portion of a media map 1500 shown in FIG. 15, the user, who does not have any media items tagged “Brian Eno”, can have the depicted structure within the “Glam Rock” region of the media map 1500. As depicted in FIG. 16, an example portion of a hierarchical tree 1600, the media items and labels are arranged accordingly.

When the user moves a media item or a region in the media map 1500 from one position to another, the corresponding changes within the hierarchical tree can affect the specific characteristics of the parent regions. The movement of into and out of a region can change the most common tags within the area and within the hierarchical tree.

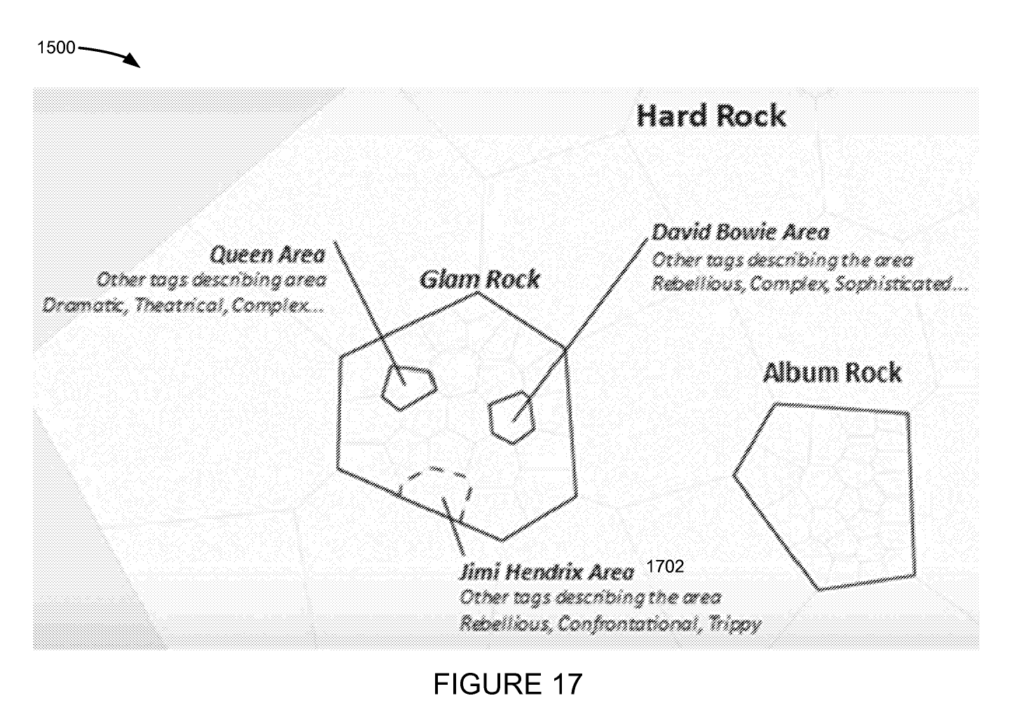

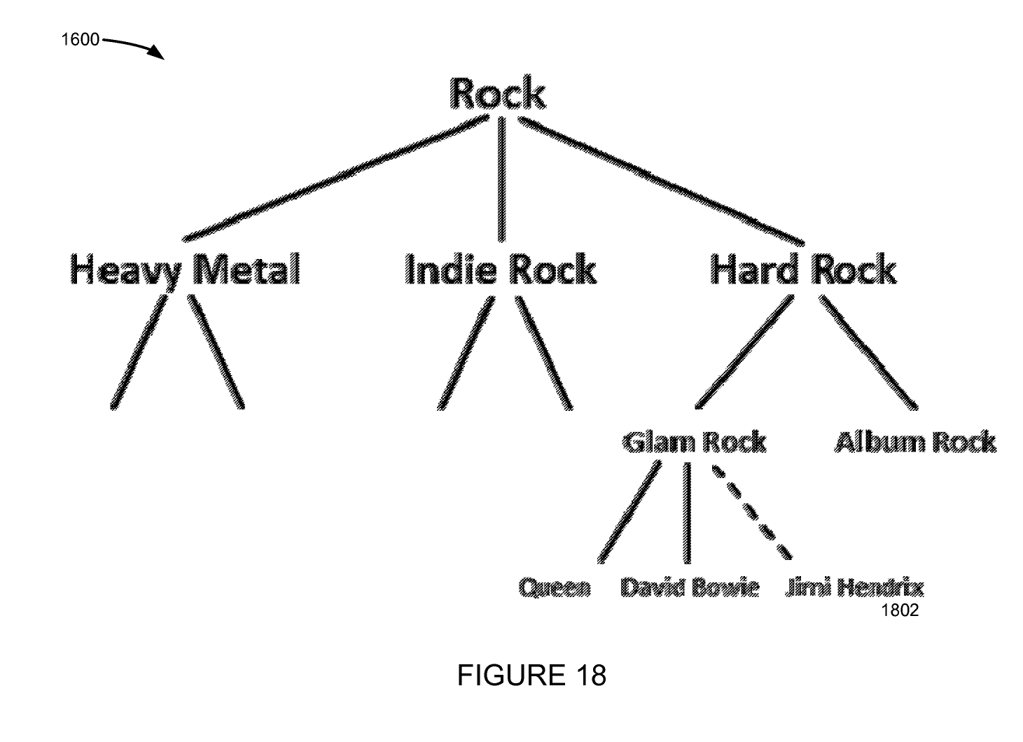

To illustrate, the user might move one or more media items that are identified by the label “Jimi Hendrix” into the larger region labelled “Glam Rock” in the media map 1500, as depicted in FIG. 17, resulting in cell 1702, labelled “Jimi Hendrix Area”. As depicted in FIG. 18, the hierarchical tree 1600 is also updated to reflect this change with addition 1802 labelled “Jimi Hendrix Area”. As an example, the user can have this structure within the “Glam Rock” cell on the media map 1500.

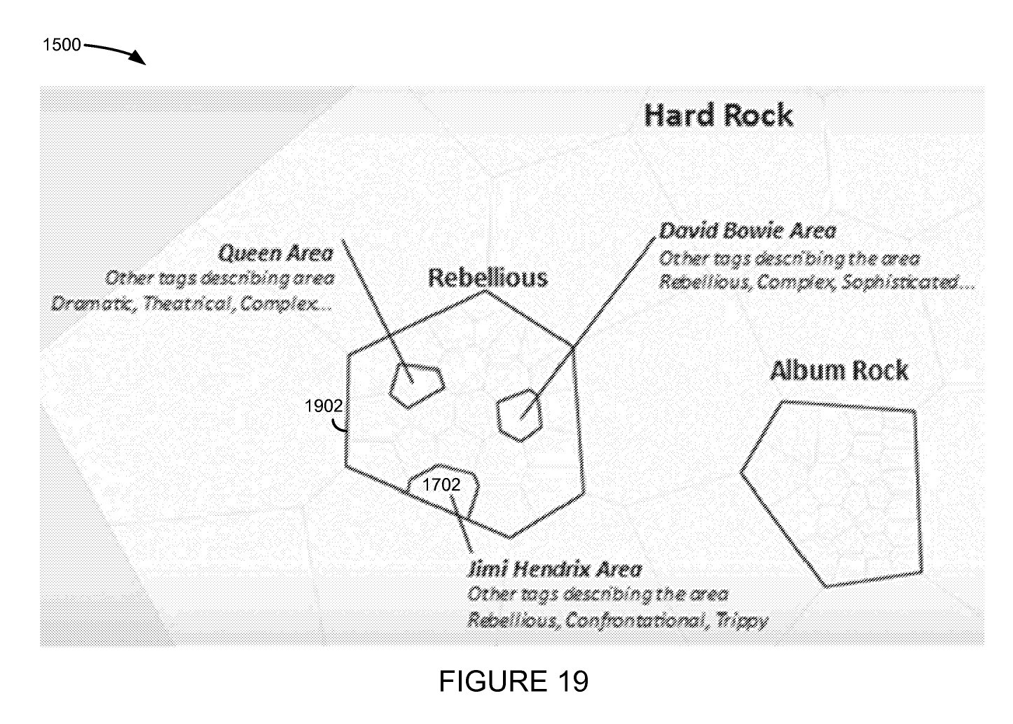

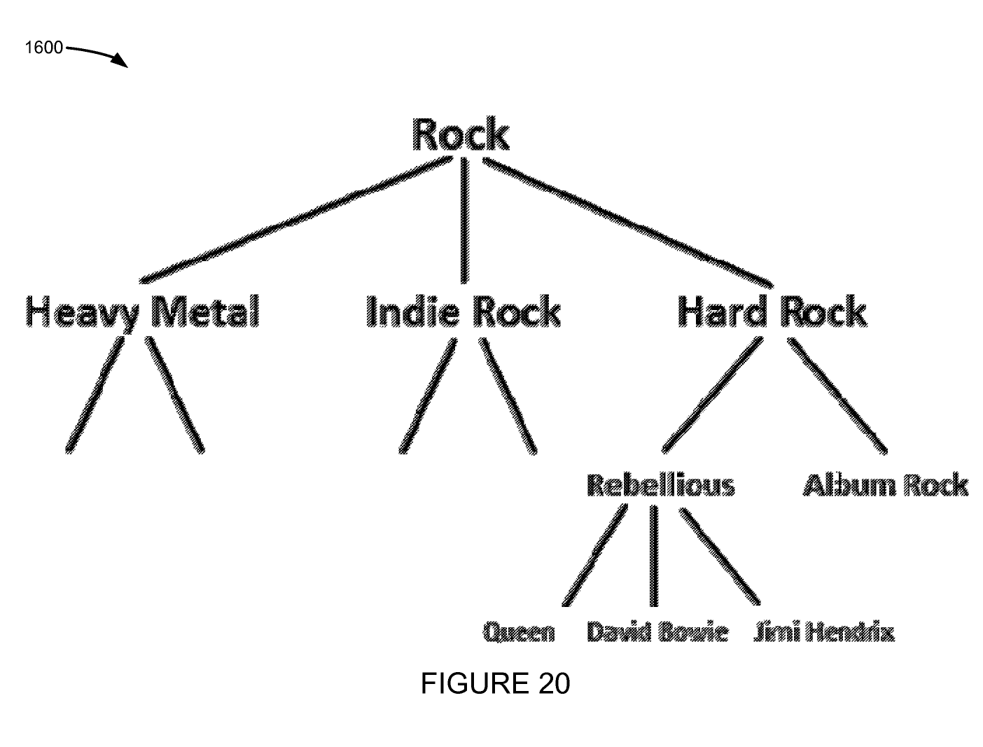

In this example, the moved song(s) by Jimi Hendrix do not have “Glam Rock” (as listed in Table 600 of FIG. 6) as a metadata tag. As such, the average weight of all tags in the sub-region has changed such that “Rebellious” is the highest-weighted tag. As depicted in FIG. 19, the area label changes from “Glam Rock” to “Rebellious”. The hierarchical tree 1600 is also updated to reflect the new label, as shown in FIG. 20.

The existing recommendations within the regions affected by the change are also updated to represent the changes within the hierarchy. In above example, the parent label change from [“Rock”->“Hard Rock”->“Glam Rock”] to [“Rock”->“Hard Rock”->“Rebellious”] for the determination of the recommendations.

At the same time, the existing recommendations from the pool of possible recommendations are re-evaluated based on the spatial structure of the neighboring regions within the larger regions. This is similar to the update of recommendations within the region based on accepting a recommendation within the area (as described above).

The system and method described herein provide recommendations of media items within a graphical presentation of other media items. The recommendations are generated based on the metadata tags associated with the prospective parent media items and the sibling media items position adjacent to the recommendation. The user can accept or reject a presented recommendation. The recommendations can be recalculated based on changes made to the media map.

The disclosed method and apparatus has been explained above with reference to several embodiments. Other embodiments will be apparent to those skilled in the art in light of this disclosure. Certain aspects of the described method and apparatus may readily be implemented using configurations other than those described in the embodiments above, or in conjunction with elements other than those described above. For example, different algorithms and/or logic circuits, perhaps more complex than those described herein, may be used.

Further, it should also be appreciated that the described method and apparatus can be implemented in numerous ways, including as a process, an apparatus, or a system. The methods described herein may be implemented by program instructions for instructing a processor to perform such methods, and such instructions recorded on a non-transitory computer readable storage medium such as a hard disk drive, floppy disk, optical disc such as a compact disc (CD) or digital versatile disc (DVD), flash memory, etc., or communicated over a computer network wherein the program instructions are sent over optical or electronic communication links. It should be noted that the order of the steps of the methods described herein may be altered and still be within the scope of the disclosure.

It is to be understood that the examples given are for illustrative purposes only and may be extended to other implementations and embodiments with different conventions and techniques. For example, embodiments described in the context of media maps can also be practiced in the context of hierarchical trees. While a number of embodiments are described, there is no intent to limit the disclosure to the embodiment(s) disclosed herein. On the contrary, the intent is to cover all alternatives, modifications, and equivalents apparent to those familiar with the art.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method comprising:
obtaining, by a computing system, a stored media map, the media map comprising media map cells corresponding to media items and at least one filler cell, the media map including a plurality of regions, each region comprising a portion of the media map cells;
identifying, by the computing system, a filler cell in a region of the plurality of regions;
generating, by the computing system, a recommendation of a media item for placement in the filler cell by:
deriving a restriction and a recommendation archetype for the filler cell from metadata tags describing the media items corresponding to the portion of the media map cells of the region comprising the filler cell,
accessing metadata tags describing media items that do not correspond to any of the media map cells,
filtering a set of recommendations of media items based on the accessed metadata tags and the restriction, and
selecting one of the filtered set of recommendations based on similarity scores indicating a relative similarity of the recommendation archetype and each of the media items in the filtered set of recommendations; and
presenting the selected recommendation in the filler cell of the media map to a user via a user display device.

2. The method of claim 1, wherein the filler cell is adjacent to a media map cell corresponding to a media item.

3. The method of claim 1, wherein identifying the filler cell further comprises identifying a predefined number of filler cells, and wherein generating the recommendation is performed for each of the predefined number of filler cells.

4. The method of claim 3, wherein the predefined number of filler cells is limited by a predefined maximum.

5. The method of claim 1, further comprising:
receiving, from the user via the user display device, an instruction to accept the selected recommendation; and
establishing a correspondence between the media item included in the selected recommendation and the filler cell.

6. The method of claim 5, further comprising:
generating a region label for the filler cell corresponding to the accepted recommended media item.

7. The method of claim 1, further comprising:
receiving, from a user via a user display device, an instruction to reject the selected recommendation; and
removing the rejected recommendation from the filler cell of the media map.

8. The method of claim 7, further comprising:
generating a second recommendation of another media item for placement in the filler cell by:
removing the rejected recommendation from the set of recommendations,
filtering the set of recommendations using the restriction resulting in a second set of recommendations, and
selecting one of the second set of recommendations based on similarity scores indicating a relative similarity of the recommendation archetype and each of the media items in the filtered set of recommendations; and
presenting the second recommendation in the filler cell of the media map to the user via the user display device.

9. The method of claim 1, further comprising:
receiving, from the user via a user display device, an instruction to move at least one of the media items in the media map to a different region;
obtaining an updated media map indicating that the at least one moved media item corresponds to at least one cell in the different region; and
generating a second recommendation of another media item for placement in the filler cell by:
deriving an updated restriction and an updated recommendation archetype for the filler cell from the metadata tags corresponding to the media items corresponding to the portion of the media map cells in the different region of the plurality of regions comprising the filler cell,
accessing metadata tags describing media items that do not correspond to any of the updated media map cells,
filtering a second set of recommendations of media items based on the updated restriction, each recommendation of the second set of recommendations identifying a media item that does not correspond to any of the media map cells in the updated media map, and
selecting one of the second set of recommendations based on similarity scores indicating a relative similarity of the recommendation archetype and each of the media items in the filtered second set of recommendations; and
presenting the second recommendation in the filler cell of the updated media map to the user via the user display device.

10. A system comprising:
a communication module configured to obtain, by a computing system, a stored media map, the media map comprising media map cells corresponding to media items and at least one filler cell, the media map including a plurality of regions, each region comprising a portion of the media map cells; and
a recommendation module configured to:
identify, by the computing system, a filler cell in a region of the plurality of regions,
generate, by the computing system, a recommendation of a media item for placement in the filler cell by:
deriving a restriction and a recommendation archetype for the filler cell from metadata tags describing the media items corresponding to the portion of the media map cells of the region comprising the filler cell,
accessing metadata tags describing media items that do not correspond to any of the media map cells,
filtering a set of recommendations of media items based on the accessed metadata tags and the restriction, and
selecting one of the filtered set of recommendations based on similarity scores indicating a relative similarity of the recommendation archetype and each of the media items in the filtered set of recommendations, and
wherein the communication module is further configured to present the selected recommendation in the filler cell of the media map to a user via a user display device.

11. A non-transitory computer-readable media having instructions embodied thereon, the instructions executable by one or more processors to perform operations comprising:
obtaining a stored media map, the media map comprising media map cells corresponding to media items and at least one filler cell, the media map including a plurality of regions, each region comprising a portion of the media map cells;
identifying a filler cell in a region of the plurality of regions;
generating a recommendation of a media item for placement in the filler cell by:
deriving a restriction and a recommendation archetype for the filler cell from metadata tags describing the media items corresponding to the portion of the media map cells of the region comprising the filler cell,
accessing metadata tags describing media items that do not correspond to any of the media map cells,
filtering a set of recommendations of media items based on the accessed metadata tags and the restriction, and
selecting one of the filtered set of recommendations based on similarity scores indicating a relative similarity of the recommendation archetype and each of the media items in the filtered set of recommendations; and
presenting the selected recommendation in the filler cell of the media map to a user via a user display device.
